(19) United States
(12) Patent Application Publication
(10) Pub. No.: US 2019/0310719 A1
(43) Pub. Date: Oct. 10, 2019

(54) ERUDITION SYSTEM FOR INVOLUNTARY ACTIVITY DETECTION AND MITIGATION ON A WEARABLE DEVICE

(71) Applicant: CA, Inc., New York, NY (US)

(72) Inventors: Vikrant NANDAKUMAR, Bangalore (IN); Lyju Rappai VADASSERY, Mumbai (IN); Vijay Shashikant KULKARNI, Bangalore (IN); Madhusudhan GANDA, Kadapa (IN)

(73) Assignee: CA, Inc.

(21) Appl. No.: 15/948,358

(22) Filed: Apr. 9, 2018

(51) Int. Cl. G06F 3/038; G04G 21/02

(52) U.S. Cl. CPC G06F 3/038; G06F 3/04883; G04G 21/02

(57) ABSTRACT

A method is described for receiving data from a first sensor associated with a first wearable device. The method further includes detecting a first activity based upon the data received from the first sensor and determining that the first activity is an incorrect activity. The method further includes determining an expected action associated with the first activity and determining a correct activity associated with the expected action. The method further includes determining whether to modify parameters of the first sensor associated with the correct activity based upon a difference between the first activity and the correct activity. The method further includes modifying the parameters of the first sensor associated with the correct activity based upon the difference between the first activity and the correct activity.

### BACKGROUND

The present invention relates generally to an erudition system for involuntary activity detection and mitigation on a wearable device.

### SUMMARY

A method is described for receiving data from a first sensor associated with a first wearable device. The method further includes detecting a first activity based upon the data received from the first sensor and determining that the first activity is an incorrect activity. The method further includes determining an expected action associated with the first activity and determining a correct activity associated with the expected action. The method further includes determining whether to modify parameters of the first sensor associated with the correct activity based upon a difference between the first activity and the correct activity. The method further includes modifying the parameters of the first sensor associated with the correct activity based upon the difference between the first activity and the correct activity.

### BRIEF DESCRIPTION OF THE DRAWINGS

Aspects of the present disclosure are illustrated by way of example and are not limited by the accompanying drawings.

FIG. 1 illustrates an erudition system in a non-limiting embodiment of the present disclosure.

FIG. 2 illustrates systems in an erudition system in a non-limiting embodiment of the present disclosure.

FIG. 3A is an illustration of an automated activity in a non-limiting embodiment of the present disclosure.

FIG. 3B is an illustration of an involuntary activity in a non-limiting embodiment of the present disclosure.

FIG. 4 is a flowchart of operations and information flows of an erudition system in a non-limiting embodiment of the present disclosure.

FIG. 5 is a flowchart of operations and information flows of involuntary activity detection in a non-limiting embodiment of the present disclosure.

FIG. 6 is a flowchart of operations and information flows of automated activity detection in a non-limiting embodiment of the present disclosure.

FIG. 7 is a flowchart of operations and information flows for determining new parameters in a non-limiting embodiment of the present disclosure.

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD- ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The present disclosure describes an erudition system for involuntary activity detection and mitigation on wearable devices. Wearable devices have been growing in number of devices and number of users, while also expanding the devices' scope and capabilities. Some of these devices have very limited capabilities, such as a step counter, while other are more sophisticated, like a smart watch. The present disclosure describes an erudition system which may work with these wearable, and other, devices and may detect incorrect activities and take actions to mitigate those involuntary or inadvertent activities.

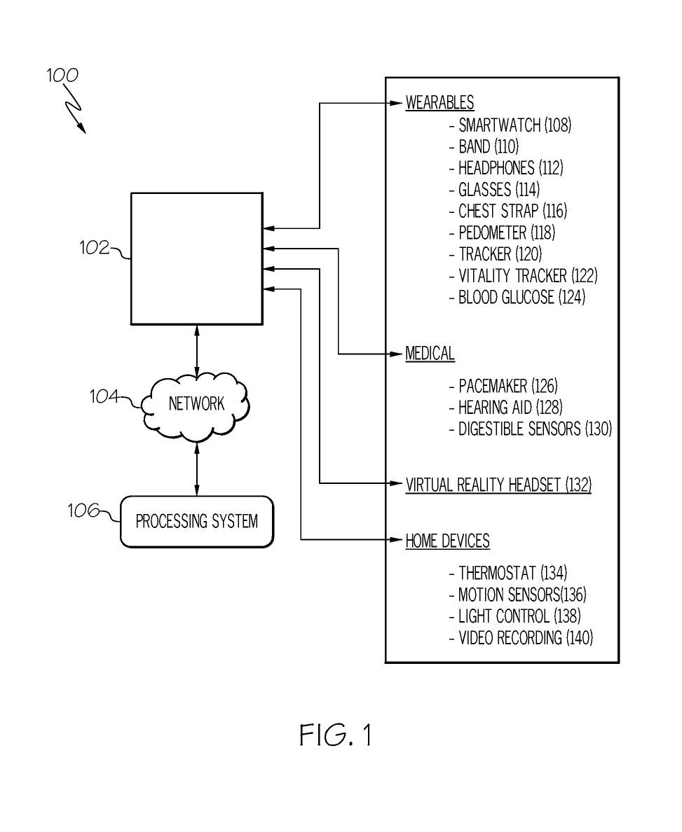

FIG. 1 illustrates an erudition system in a non-limiting embodiment of the present disclosure. An erudition system 100 may include a mobile device 102, a network 104, a processing system 106, wearable devices 108-124, and other devices 126-140. The erudition system 100 may exist on a single device, or across multiple devices. The erudition system 100 may detect inadvertent or involuntary activities, and may determine actions to mitigate those activities in the futures.

The mobile device 102 may be connected to a plurality of wearable and other devices. In some embodiments, the mobile device 102 hosts the erudition system 100 itself In embodiments where the erudition system 100 exists on the mobile device 102, it is not necessary for the mobile device 102 to be connected to either a larger network 104 or a separate processing system 106. The mobile device 102 may be connected to the wearable devices 108-124 and other devices 126-140 through a variety of different connection methods and protocols (e.g., Bluetooth, radio frequency, near-field communication, RFID, WiFi, USB).

Network 104 may comprise one or more entities, which may be public, private, or community based. Network 104 may permit the exchange of information and services among users/entities that are connected to such network 104. In certain configurations, network 104 may be a local area network, such as an intranet. Further, network 104 may be a closed and/or private network/cloud in certain configurations, and an open network/cloud in other configurations. Network 104 may facilitate wired or wireless communications of information and provisioning of services among users that are connected to network 104.

The processing system 106 may be connected to the mobile device 102 through a network 104 or by other methods. The processing system 106 may be where the erudition system 100, or portions thereof, exists. In embodiments where the processing system 106 hosts portions of the erudition system 100, information may flow from the sensors on the wearable devices 108-124 and other devices 126-140 to the mobile device 102 to the processing system 106. The processing system 106 may store information received from the wearable devices 108-124 and other devices 126-140. The processing system 106 may detect involuntary or inadvertent activity within the information received from the devices. The processing system 106 may determine actions to take to mitigate the involuntary or inadvertent activity. The processing system 106 may communicate back to the mobile device 102 or the wearable device or other device the new actions to take.

The wearable devices 108-124 may be connected to the mobile device 102 or may be connected to another device controlled by a user (e.g., computer, tablet, home hub, personal hub). The wearable devices may be physically connected to the user (e.g., a smartwatch, smart eyeglasses). In some embodiments, the wearable devices may be secondarily attached to the user (e.g., pedometer located within the user's shoe). In some embodiments, the wearable device may be associated with, or worn by, a second user.

The other devices 126-140 may also be integrated into the erudition system 100. The device may be used to augment the erudition system 100 to integrate additional sensors to detect inadvertent or involuntary activity. The device may also be used by the erudition system 100 to create more sophisticated activity mitigation parameters using the wearable device sensors along with the other device sensors. The other devices may be connected directly to the mobile device 102 or processing system 106, through the network 104 to either the mobile device 102 or the processing system 106, or through a variety of other methods.

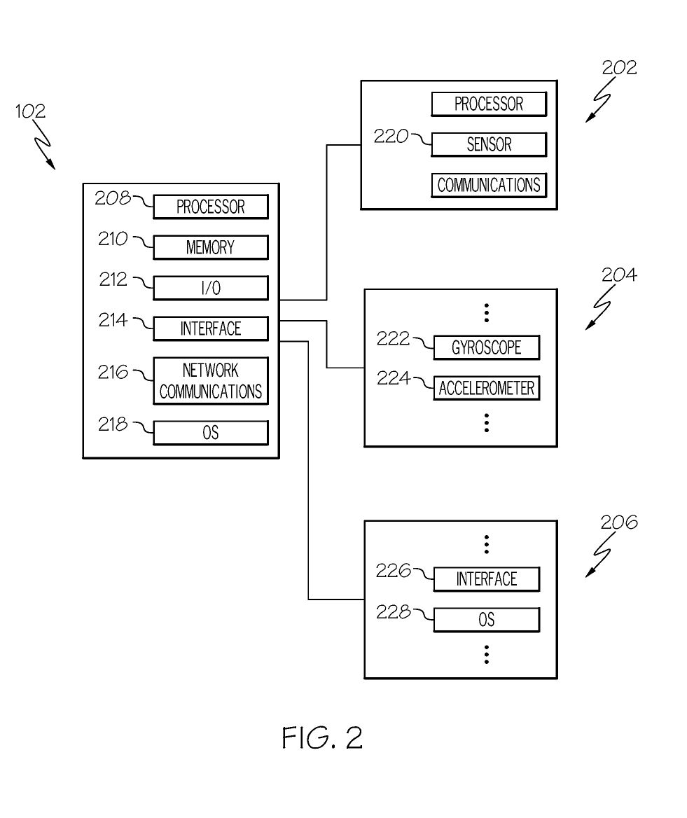

FIG. 2 illustrates systems in an erudition system in a non-limiting embodiment of the present disclosure. The systems of the erudition system 100 may include the mobile device 102, and devices 202-206.

The mobile device 102 and/or the processing system 106 may include any of the following as necessary to provide the functions of the erudition system 100 within a specific embodiment. They may include a processor 208, volatile and/or non-volatile memory 210, input/output devices 212, one or more interfaces 214, network or other wired or wireless communications 216, and an operating system 218.

The devices 202-206 may include as few or as many of the following components as needed for the activity of the device. Some devices, such as simple sensors (e.g., temperature, motion) may have as few components as possible to transmit basic information. Other devices may have much more complicated functions and sensors which require more complex processing and thus include more complex components. In some embodiments the devices may include a processor 208, volatile and/or non-volatile memory 210, input/output devices 212, one or more interfaces 226, network or other wired or wireless communications 216, an operating system 228, and sensors 220 (e.g., gyroscope 222, accelerometer 224, temperature, GPS, motion sensor, pressure sensor, touchscreen press coordinates, touchscreen pressure, buttons, switches, light sensor, audio sensor, video, heartbeat, blood chemistry).

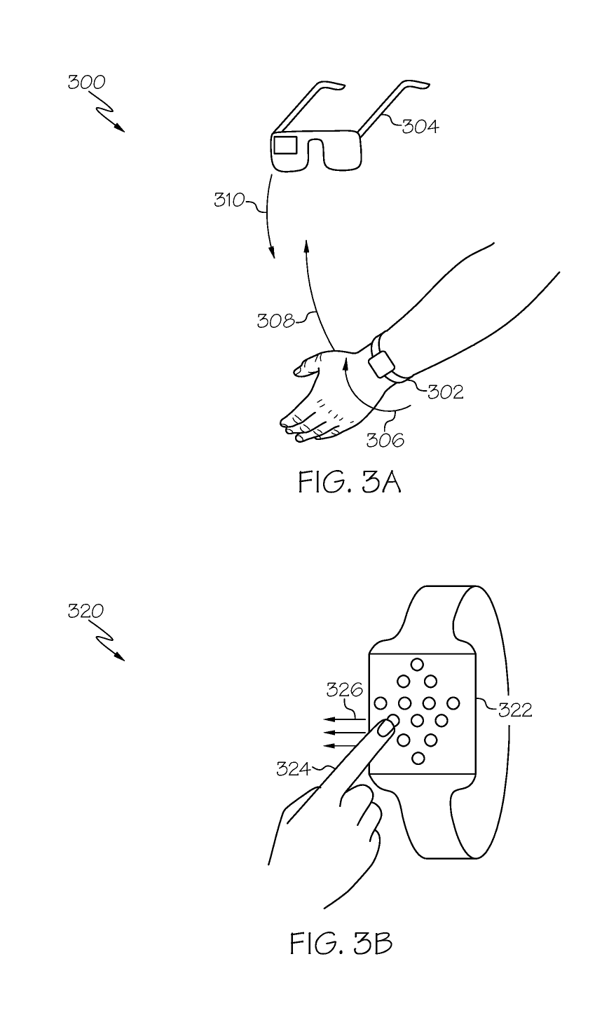

FIG. 3A is an illustration of an automated activity in a non-limiting embodiment of the present disclosure. The automated activity 300 being depicted by the illustration is to turn on the screen of a smartwatch 302. The automated activity 300 may be triggered by a variety of different activities taken by the user. Each automated activity 300, or any activity, may be considered to have parameters associated with the sensors associated with the activity, such that those parameters define the values those sensors must take to trigger the expected action for the activity.

In an embodiment, the expected action for the automated activity 300 may be triggered by the user simply turning their wrist as depicted by the activity 306. In those embodiments, the expected action of the automated activity 300 may be triggered by the gyroscope of the smartwatch 302 detecting a rotation of a certain number of degrees. The parameters in that embodiment may identify at least the gyroscope as the sensor and the degree change as the parameter and value.

It is important to note that if this expected action of the automated activity 300 does not occur for some reason, the user may decide to manually invoke the action that was meant to the automated. This may often happen within a short time period (e.g., microseconds, less than two seconds) after the expected occurrence of the automated activity 300. In the embodiment described above, when the user turns his wrist 306 but the smartwatch 302 fails to turn on, the user may push a button on the smartwatch to manually turn on the screen. The activity to manually trigger an action that is automated may indicate an incorrect trigger for the expected action of the automated activity 300 and may lead to an adjustment of the parameters for the sensors associated with the automated activity 300.

The automated activity 300, in another embodiment, may require the user to both turn their wrist 306 and raise their hand 308 before the automated activity 300 to turn on the smartwatch 302 screen is triggered. The addition of this second action to trigger the automated activity 300 may involve additional sensors like the accelerometer. The automated activity 300, in this embodiment, may require that the accelerometer detect a movement of a certain threshold acceleration 308 within a certain period of time before, during and/or after the gyroscope detected a rotation 306.

The automated activity 300, in another embodiment, may require the user to turn their wrist 306, raise their hand 308, and look down 310. In this embodiment, the user may have a smartwatch 302 as well as smart eyeglasses 304. The smart eyeglasses 304 may use a gyroscope, video detection, or other sensors to allow the erudition system 100 to identify when the user looks down 310. The automated activity 300 may now involve multiple sensors across two devices to provide the simple activity of turning on a watch screen when a user looks at it. An advantage of the present disclosure may be to provide a more responsive and individualized system which integrates these disparate systems and adapts to the user's behaviors.

FIG. 3B is an illustration of an involuntary activity in a non-limiting embodiment of the present disclosure. The involuntary activity 320 depicted in FIG. 3B may comprise a smartwatch 322, a user's finger 324, and an action 326. The depicted involuntary activity 320 may be an activity to swipe the smartwatch screen to trigger an action to change the information displayed on the smartwatch screen. In some embodiments, the erudition system 100 may define the swipe activity of 326 using parameters for the touchscreen position sensors and the touchscreen pressure sensors on the smartwatch 322. In some embodiments, the parameters for the touchscreen position sensors may identify the position change necessary to detect a swipe activity. In some embodiments, the parameters for the touchscreen position sensors may also identify a valid beginning position for any left swipe activity. The parameters for the touchscreen position sensor may additionally identify the rate of change of position (e.g., the speed of the swipe) necessary to constitute a swipe activity. If the erudition system 100 detects a swipe, an action may be triggered to change the content of the smartwatch screen 322.

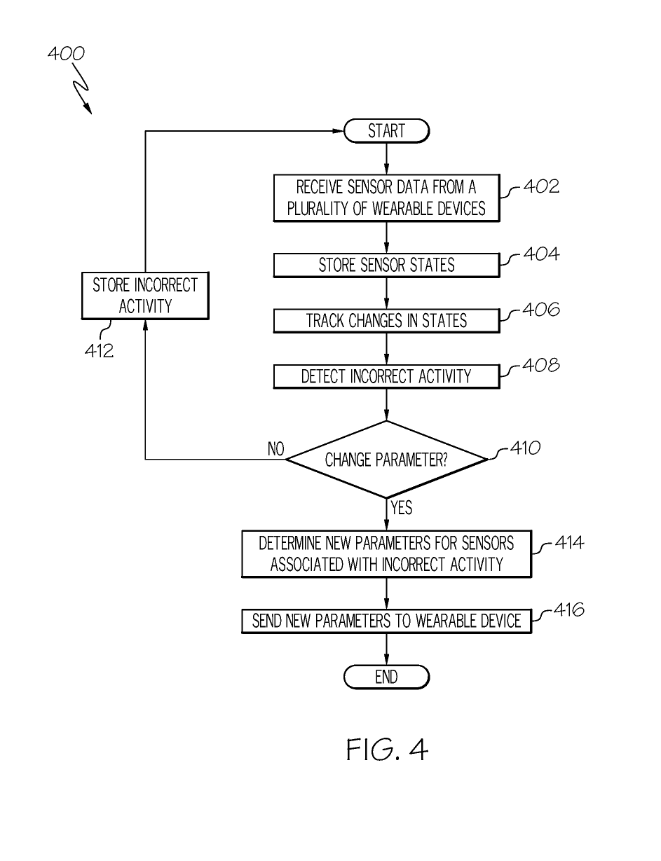

FIG. 4 is a flowchart of operations and information flows of an erudition system in a non-limiting embodiment of the present disclosure. The flowchart of operations 400 describes the way the erudition system may receive sensor data from the wearable devices, store that information, detect incorrect actions, determine new parameters for the incorrect action, and send the new parameters to the wearable device.

In step 402, the erudition system may receive sensor data from one or many sensors associated with one or many devices. The devices that the erudition system may receive sensor data from are not limited to wearable devices, but may include other devices (e.g., medical devices, smart home devices, internet-of-things devices). The sensors associated with these devices may vary widely. The data received from the devices may be continuous or intermittent, in real-time or delayed, and wirelessly or with a direct wired connection. In some embodiments, the data obtained from the sensors indicates a state associated with the sensor of the wearable device. The states of multiple sensors for a given device may be combined together to identify a state for the device. In other embodiments, the sensors associated with certain activities (e.g., the gyroscope and accelerometer used to turn on a smartwatch screen) may be grouped together to identify a state for the activity rather than the wearable device.

In step 404, the erudition system 100 stores the states of the sensors received in step 402. The states may be stored in short or long-term storage. In some embodiments, the states may be stored in a database or other structured data system. In some embodiments, the storage may happen on the mobile device 102. In other embodiments, the state storage might be conducted by the processing system 106. An advantage of the erudition system 100 storing the state of the sensors may be that the erudition system 100 can make choices for how to trigger activities based on not just the current state of the sensors, but historical states as well.

Step 406 describes the operation of tracking changes in the states of the sensors stored in step 404. The tracking of changes in the states may consist of chaining together states temporally to determine the change in states. In other embodiments, the tracking may occur in combination with an action taken (e.g., noting change in state during a user swipe on a screen) or in combination with the activity parameters (e.g., noting the change in state when the gyroscope exceeds a threshold rotation in a particular axis). The tracking described in step 406 may not exist in each embodiment of the erudition system 100, and indeed may be missing from many embodiments of the present invention.

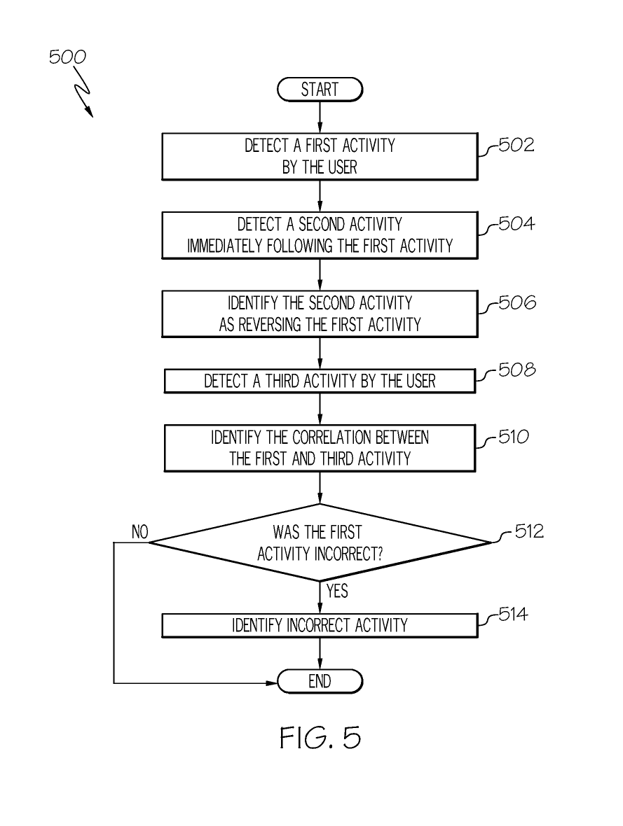

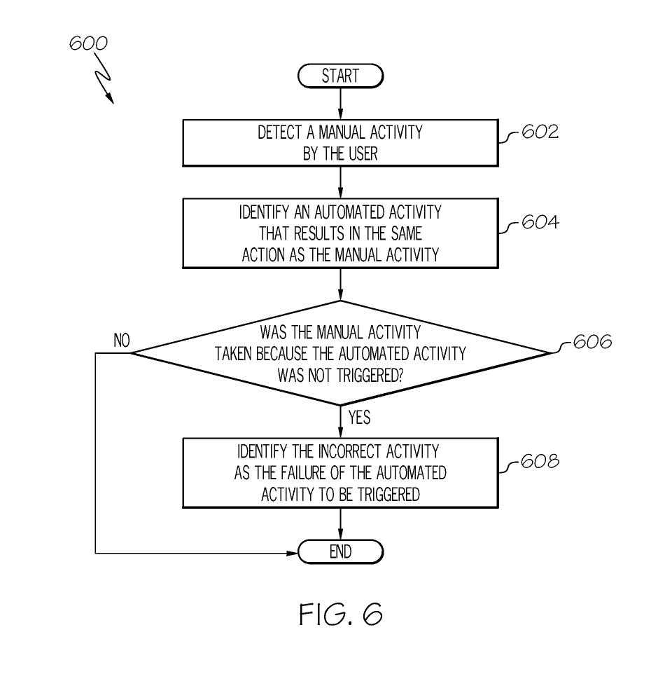

In step 408, the erudition system 100 detects an incorrect activity. The incorrect activity may be a touchscreen finger press that led to the wrong submenu. In other embodiments, the incorrect activity may be an automated activity that was expected to be triggered, but failed to trigger (e.g., turning wrist and raising hand should turn on the smartwatch screen). The incorrect activity can be any activity that is defined with the erudition system 100. The detection of an incorrect activity is described in further detail in FIG. 5 and FIG. 6.

After detecting an incorrect activity in step 408, the erudition system 100 may determine whether to take action to change the parameters associated with the activity in step 410. If the erudition system 100 determines not to change the parameters, then the erudition system, in step 412, may store the incorrect action details for later reference if the same incorrect action is encountered again. If the erudition system 100 decides to take action to change the parameters, the erudition system 100 may then determine the new parameters for the incorrect activity in step 414. In step 410, the erudition system 100 may consider many different factors in determining whether to change the parameters associated with an incorrect activity, including how close the incorrect activity was to being triggered, the historical behavior of the incorrect activity, how effective the change in parameters will be in changing the incorrect behavior, and how adaptive the user wants the erudition system 100 to be in reacting to incorrect activities. In some embodiments, the erudition system 100 may invite the user to set a sensitivity threshold for how often or how aggressively the system should change activity behavior in response to detecting an incorrect activity.

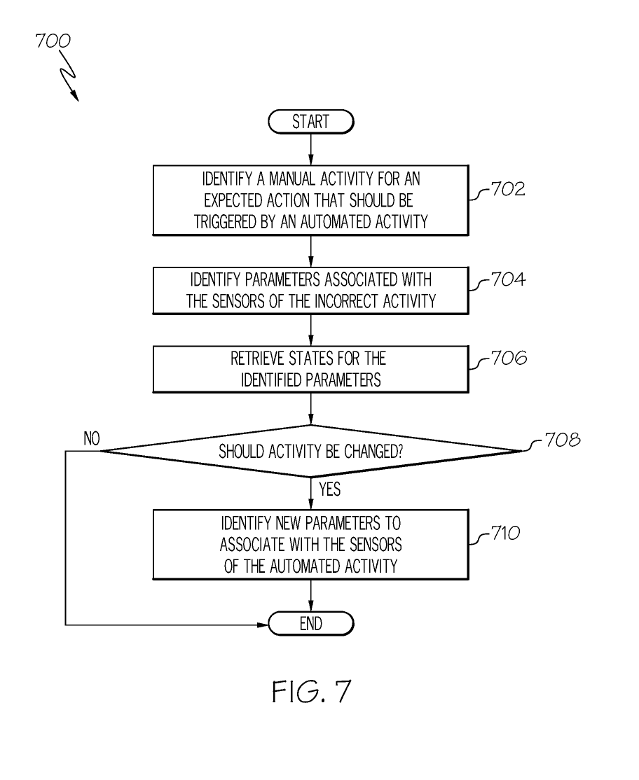

Step 414 describes how the erudition system 100 determines the new parameters values for the incorrect activity. The new parameters may be identified in different ways, and some of those ways are further described in FIG. 7. The new parameters determined in step 414 may include changes to one or more sensors and one or more devices associated with the incorrect activity. In some embodiments, the parameters may represent the physical attributes of the real-world sensor (e.g., temperature, GPS location). In some embodiments, the parameters may represent threshold values which must be crossed in order for the activity to be triggered.

The erudition system 100, after detecting an incorrect activity and determining new parameters to associate with that activity, may send the new parameters to the plurality of wearable devices in step 416. Step 416 makes a physical change in the erudition system 100 by setting new parameters for an activity within each sensor on each wearable device associated with that activity. For example, in an embodiment described in FIG. 3A, after a change in the gyroscope rotation parameters necessary to trigger the screen to turn on, the physical reaction of the wearable device to its environment changes and the operation of watch changes.

FIG. 5 is a flowchart of operations and information flows of involuntary activity detection in a non-limiting embodiment of the present disclosure. The flowchart of the involuntary activity detection 500 expands upon step 408 where the erudition system 100 detects an incorrect activity. In some embodiments, a way to detect an incorrect activity may be to identify an involuntary activity. An involuntary activity may be classified as an activity that did not match the intention of the user. Some non-limiting examples of such embodiments may include accidentally pressing the wrong button, having an automatic activity be triggered when the user did not expect to trigger the automatic activity, and a visual gesture which is incorrectly interpreted as a different gesture.

In some embodiments, the involuntary action detection 500 may begin by detecting a first action by the user in step 502. This first action may be any action taken by the user; restrictions on what the first action may be only in relation to the third action. The first action, as well as any other action, may be an action not explicitly taken by the user, but may be an action taken by the erudition system 100, the wearable device, or any other entity. An example of the first action, in a non-limiting embodiment of the present disclosure, may be selecting a first application from a plurality of applications displayed on the main screen of a smartwatch.

Following detection of the first action in step 502, the erudition system 100 may detect, in step 504, a second action immediately following the first action. The second action may take place in a short period of time (e.g., in milliseconds, in less than one second, in less than two seconds) after the first action. The short period of time between the first action and the second action may be necessary to identify the second action as reversing the first action, as described in step 506. An example of the second action, in a non-limiting embodiment of the present disclosure, may be pushing a button to return to the previous screen.

Once the second action is detected, the erudition system 100 may identify the second action as reversing the first action in step 506. The second action may be comprised of multiple sub-actions, which together combine to constitute the second action. In some embodiments, the second action may be as simple as an action returning the user to the previous screen. In other embodiments, the second action may be more complex, such as sending a command to an automated vehicle to reverse the current path. In step 506, the erudition system 100 may use previously stored information that identifies a plurality of second actions which reverse a plurality of first actions. In some embodiments, the erudition system 100 may dynamically determine if a second action is reversing a first action based on knowledge of the operations of the user and the wearable device or other device.

In step 508, the erudition system 100 detects a third action taken by the user. The third action may be taken in a short period of time (e.g., in milliseconds, in less than one second, in less than two seconds) after the second action. The third action may be a single action, or may be comprised of multiple sub-actions, which together combine to constitute the third action. A purpose of the third action may be to execute an action that was intended by the user when the first action was taken instead.

After detecting the third action in step 508, the erudition system 100, in step 510, may identify a correlation between the first and third actions. The correlation between the first action and the third action may be identified based on location of the actions, the temporal similarity of the actions, similarity of the resulting action, similarity of the resulting state of the wearable device or other device, or any other method of correlating one action to another. The method of correlating two actions may vary widely among devices based on the type of actions and functionality available to the wearable device or other device.

After identifying the correlation between the first and third actions in step 510, the erudition system 100, in step 512, may determine if the first action was an incorrect action. An incorrect action is an action that was not meant to be taken. In some embodiments, the incorrect action may be an inadvertent action (e.g., an accidental press of a button), an involuntary action (e.g., a smartwatch screen turning on when the user did not intend the screen to turn on), or any other action the user may not want to occur. In determining whether the first action was an incorrect action, the erudition system 100 may consider the correlation between the first and third action, knowledge of the user's intentions, or any other method of detecting an incorrect action available to the erudition system 100. If the first action is determined to be an incorrect action in step 512, the erudition system will identify the first action as an incorrect action and an incorrect activity in step 514. Identifying the first action as an incorrect activity may be necessary to complete step 408 of the erudition system flowchart of operations 400.

FIG. 6 is a flowchart of operations and information flows of automated activity detection in a non-limiting embodiment of the present disclosure. The automated activity detection 600 may be necessary to complete step 408 of the erudition system flowchart of operations 400. The automated activity detection 600 may comprise detecting a manual action, identifying an automated action that would result in the same action as the manual action, determining if the user expected the automated action to be taken, and identifying the incorrect activity.

The automated activity detection 600 begins with the erudition system 100 detecting a manual action by the user in step 602. A manual action taken by the user may be any action that the user can take, and may include pressing a button, touching a touchscreen, orienting a device in a particular way (e.g., shaking a device), or any other action that can be intentionally taken by the user. The actions detected for the purpose of step 602 may be limited, in some embodiments, to actions that have automated activities that result in the same activity on the wearable device or other device (e.g., pressing a button on a smartwatch turns the screen on and rotating a user's wrist automatically turns on the screen).

After detecting a manual action by the user in step 602, the erudition system 100, in step 604, may identify an automated activity that results in the same activity as the manual action. In some embodiments, the identification of the automated activity may occur prior to the detection of the manual activity. In some embodiments, the erudition system 100 may determine the automated activities related to manual actions when the erudition system 100 incorporates the wearable device or other device, or the activities of the devices. The erudition system 100 may identify automated activities that result in the same activity as a manual action to, in some embodiments, aid in determining whether the automated activity should have been triggered.

In step 606, the automated activity detection 600 determines if the manual action was taken because the automated activity was not triggered. The method of this determination may vary widely based on the devices and sensors used to trigger the automated activity. In some embodiments, the determination that the automated activity was incorrectly not triggered may be based on historical analysis of the states of the sensors associated with the automated activity. In some embodiments, the determination may be based on the fact that the user attempted actions that are similar to the automated activity, thereby implying that the user was attempting to trigger the automated activity. In some embodiments, the determination may be based on input from the user, either through the manual action or through another action, indicating that the user intended the automated action to be triggered.

If, in step 606, the erudition system 100 determines that the manual action was taken because the automated activity was not triggered, then the erudition system 100, in step 608, may identify the incorrect activity of step 408 as the failure of the automated action to be triggered. The failure of the automated activity to be triggered may indicate that the parameters of the sensors associated with the activity are incorrect. Identifying the incorrect activity as the failure to trigger the automated activity may allow the erudition system 100 to investigate why the automated activity was not triggered, determine if a modification of the automated activity is warranted, and determine how to modify the automated activity.

FIG. 7 is a flowchart of operations and information flows for determining new parameters in a non-limiting embodiment of the present disclosure. The information flow for determining new parameters 700 may be the process the erudition system 100 uses to determine the new parameters for the incorrect activity as described in step 414 of the erudition system information flow 400. The information flow for determining new parameters 700 may comprise identifying an incorrect activity, identifying parameters associated with the incorrect activity, retrieving states for the identified parameters, determining if the activity should be changed, identifying new parameters to associate with the automated activity.

In step 702, the erudition system 100 may, in a non-limiting embodiment of the present disclosure, identify an incorrect activity that comprises an automated activity that incorrectly failed to trigger. The determination and identification of the incorrect activity may have occurred previously in step 408. Following the identification of the incorrect activity, the erudition system 100, in step 704, may identify parameters associated with the incorrect activity.

Identifying the parameters associated with the incorrect activity, in step 704, may involve identifying each of the wearable devices associated with the incorrect activity. In some embodiments, an activity may be associated with multiple wearable devices. In some embodiments, the each of the wearable devices associated with the activity may have one or more sensors. All, or a subset, of the sensors associated with a wearable device may also be associated with a given activity. Each of the sensors associated with the activity may also have parameters associated with the activity, where each sensor may have multiple parameters each of which may be associated with a different activity.

For example, in FIG. 3A, in a non-limiting embodiment of the current disclosure, the incorrect activity of failing to turn on the smartwatch screen may be associated with both the smartwatch 302 and smart eyeglasses 304. The smartwatch 302 may have many sensors, including a gyroscope, accelerometer, and a touchscreen. Similarly, the smart eyeglasses 304 may have many sensors, including a video capture device, gyroscope, and accelerometer. In the example automated activity of turning on the smartwatch screen depicted in FIG. 3A, the automated activity may only be associated with the accelerometer and gyroscope of the smartwatch 302, and the gyroscope of the smart eyeglasses 304. Thus, the automated activity may not be associated with the other sensors of the smartwatch 302 or smart eyeglasses 304. Each of the sensors associated with the automated activity may also have parameters that define certain behaviors for that sensor for one or more activities. In the non-limiting embodiment of FIG. 3A, the gyroscope of the smartwatch 302, for example, may have parameters that define the angular rotation necessary to trigger the automated action of turning on the smartwatch screen. The gyroscope of the smartwatch 302 may also have other parameters that are associated with other activities. The gyroscope of the smartwatch 302 may also associate the specific angular rotation parameters for the automated activity to other activities. Thus, the parameters may be specific to a particular sensor on a particular device, all of which may be associated with one or more activities.

After identifying the parameters associated with the incorrect activity, the erudition system 100, in step 706, retrieves the states for the identified parameters. The states for the identified parameters may be the same states received from the wearable device in step 402 and/or the states stored in step 404. The states may include information necessary to determining the behavior of the sensor and understanding the relationship between the sensor and the parameters. For example, in the non-limiting embodiment depicted in FIG. 3A, the state of the gyroscope on the smartwatch 302 may include the degrees of rotation of the sensor, in relation to an initial position, with respect to each combination of axis and planes. This individual state, however, may not provide the information necessary to determine if a gyroscope has rotated certain degrees with respect to a specific axis within the last second. In order to make that determination, the erudition system 100 may need to inspect multiple historical states to determine whether the change in the states indicates the angular rotation defined in the parameter.

Based on the retrieved states for the identified parameters, the erudition system 100, in step 708, may determine whether the parameters for the incorrect activity should be changed. In some embodiments, the determination in step 708 may incorporate a threshold, where the threshold identifies how similar the expected parameter is to the detected state(s) before changing the parameters for the incorrect activity. In some embodiments, the threshold may include a frequency of how many times the incorrect activity must be detected before a change in activity occurs. In some embodiments, the determination of step 708 may include input from the user indicating that the parameters of the incorrect activity should be changed.

If the erudition system 100 in step 708 determines that the incorrect activity should not be changed, then no new parameters are identified and the information flow for determining new parameters 700 may end. However, if the erudition system 100 in step 708 determines that the incorrect activity should be changed, the erudition system 100 may identify the new parameters to associate with the automated activity. The identification of the new parameters to associate with the automated activity may be heavily dependent on the specific sensor and the specific type of activity. In some embodiments, the erudition system may be able to compare the states retrieved in step 706 with the parameters identified in step 704 to determine the new parameters to associate with the automated activity. In some embodiments, a more complex analysis may be required by the erudition system 100 to determine the new parameters to associate with the automated activity (e.g., multiple sensor analysis, threshold analysis, shortest path analysis, rotation vector analysis, vector path analysis). In some embodiments, the erudition system 100 may identify additional sensors, and new parameters associated with the additional sensors, not currently associated with the incorrect activity to add to the incorrect activity in order to fix the incorrect behavior of the activity.

The flowchart and block diagrams in the figures illustrate examples of the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order illustrated in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
receiving data from a first sensor associated with a first wearable device;
detecting a first activity based upon the data received from the first sensor;
determining that the first activity is an incorrect activity;
determining an expected action associated with the first activity;
determining a correct activity associated with the expected action;
determining whether to modify parameters of the first sensor associated with the correct activity based upon a difference between the first activity and the correct activity; and
modifying the parameters of the first sensor associated with the correct activity based upon the difference between the first activity and the correct activity.

2. The method of claim 1, further comprising:
receiving data from a second sensor associated with the first wearable device;
wherein detecting the first activity further comprises detecting the first activity based upon the data received from the second sensor associated with the first wearable device; and
determining whether to modify parameters of the second sensor associated with the correct activity based upon the difference between the first activity and the correct activity.

3. The method of claim 1, wherein determining that the first activity is an incorrect activity further comprises:
detecting a second activity taken following the first activity;
determining whether the second activity reversed the first activity;
detecting a third activity taken following the second activity; and
wherein the determination that the first activity is the incorrect activity is based at least in part upon a probability that the third activity was intended by a user, instead of the first activity.

4. The method of claim 1, wherein determining that the first activity is an incorrect activity further comprises:
detecting a manual activity taken in response to a failure of the first activity to trigger the expected action;
determining a triggered action in response to the manual activity; and
determining that the expected action comprises the triggered action.

5. The method of claim 1, wherein the data comprises first data and the parameters comprise first parameters, and further comprising:
receiving second data from a second sensor associated with a second wearable device;
wherein the first activity and the correct activity are each associated with the first sensor and the second sensor;
determining whether to modify second parameters of the second sensor based upon the difference between the first activity and the correct activity; and
transmitting first and second instructions to the first and second wearable devices, respectively, to modify the first and second parameters.

6. The method of claim 1, further comprising:
storing the data received from the first sensor associated with the first wearable device, the data comprising a state of the first sensor;
wherein the data is received continuously, in real-time;
tracking changes in the state of the first sensor after the data is received; and
storing the changes in the state of the first sensor.

7. The method of claim 1, further comprising:
identifying parameters for a second sensor associated with the incorrect activity;
retrieving stored states for each of the first and second sensors associated with the incorrect activity;
comparing each of the stored states to respective expected states associated with the correct activity; and
determining whether to modify the parameters for the first sensor associated with the correct activity and the parameters for the second sensor associated with the correct activity based at least in part upon the comparison of the stored states with the expected states.

8. The method of claim 7, wherein the second sensor is associated with a second wearable device.

9. The method of claim 8, further comprising transmitting first and second instructions to the first and second wearable devices, respectively, to modify the parameters of the first sensor and the parameters of the second sensor.

10. A computer configured to access a storage device, the computer comprising:
a processor; and
a non-transitory, computer-readable storage medium storing computer-readable instructions that when executed by the processor cause the computer to perform:
receiving data from a first sensor associated with a first wearable device;
detecting a first activity based upon the data received from the first sensor;
determining that the first activity is an incorrect activity;
determining an expected action associated with the first activity;
determining a correct activity associated with the expected action;
determining whether to modify parameters of the first sensor associated with the correct activity based upon a difference between the first activity and the correct activity; and
modifying the parameters of the first sensor associated with the correct activity based upon the difference between the first activity and the correct activity.

11. The computer of claim 10, wherein the computer-readable instructions further cause the computer to perform:
receiving data from a second sensor associated with the first wearable device;
wherein detecting the first activity further comprises detecting the first activity based upon the data received from the second sensor associated with the first wearable device; and
determining whether to modify parameters of the second sensor associated with the correct activity based upon the difference between the first activity and the correct activity.

12. The computer of claim 10, wherein determining that the first activity is an incorrect activity further comprises:
detecting a second activity taken following the first activity;
determining whether the second activity reversed the first activity;
detecting a third activity taken following the second activity; and
wherein the determination that the first activity is the incorrect activity is based at least in part upon a probability that the third activity was intended by a user, instead of the first activity.

13. The computer of claim 10, wherein determining that the first activity is an incorrect activity further comprises:
detecting a manual activity taken in response to a failure of the first activity to trigger the expected action;
determining a triggered action in response to the manual activity; and
determining that the expected action comprises the triggered action.

14. The computer of claim 10, wherein the data comprises first data and the parameters comprise first parameters, and wherein the computer-readable instructions further cause the computer to perform:
receiving second data from a second sensor associated with a second wearable device;
wherein the first activity and the correct activity are each associated with the first sensor and the second sensor;
determining whether to modify second parameters of the second sensor based upon the difference between the first activity and the correct activity; and
transmitting first and second instructions to the first and second wearable devices, respectively, to modify the first and second parameters.

15. The computer of claim 10, wherein the computer-readable instructions further cause the computer to perform:
storing the data received from the first sensor associated with the first wearable device, the data comprising a state of the first sensor;
wherein the data is received continuously, in real-time;
tracking changes in the state of the first sensor after the data is received; and
storing the changes in the state of the first sensor.

16. The computer of claim 10, wherein the computer-readable instructions further cause the computer to perform:
identifying parameters for a second sensor associated with the incorrect activity;
retrieving stored states for each of the first and second sensors associated with the incorrect activity;
comparing each of the stored states to respective expected states associated with the correct activity; and
determining whether to modify the parameters for the first sensor associated with the correct activity and the parameters for the second sensor associated with the correct activity based at least in part upon the comparison of the stored states with the expected states.

17. The computer of claim 16, wherein the second sensor is associated with a second wearable device.

18. The computer of claim 17, further comprising transmitting first and second instructions to the first and second wearable devices, respectively, to modify the parameters of the first sensor and the parameters of the second sensor.

19. A computer program product comprising:
a computer-readable storage medium having computer-readable program code embodied therewith, the computer-readable program code comprising:
computer-readable program code configured to receive data from a first sensor associated with a first wearable device;
computer-readable program code configured to detect a first activity based upon the data received from the first sensor;
computer-readable program code configured to determine that the first activity is an incorrect activity, wherein determining that the first activity is an incorrect activity further comprises:
computer-readable program code configured to detect a second activity taken following the first activity;
computer-readable program code configured to determine whether the second activity reversed the first activity;
computer-readable program code configured to detect a third activity taken following the second activity; and
wherein the determination that the first activity is the incorrect activity is based at least in part upon a probability that the third activity was intended by a user, instead of the first activity;
computer-readable program code configured to determine an expected action associated with the first activity;
computer-readable program code configured to determine a correct activity associated with the expected action;
computer-readable program code configured to determine whether to modify parameters of the first sensor associated with the correct activity based upon a difference between the first activity and the correct activity; and
computer-readable program code configured to modify the parameters of the first sensor associated with the correct activity based upon the difference between the first activity and the correct activity.
